(19) United States
(12) Patent Application Publication
(10) Pub. No.: US 2017/0322438 A1
(43) Pub. Date: Nov. 9, 2017

(54) CURVED LIQUID CRYSTAL DISPLAY PANEL AND ARRAY SUBSTRATE THEREOF

(71) Applicant: SHENZHEN CHINA STAR OPTOELECTRONICS TECHNOLOGY CO., LTD., Guangdong (CN)

(72) Inventor: Chengliang YE, Guangdong (CN)

(21) Appl. No.: 14/906,727

(22) PCT Filed: Jan. 6, 2016
(86) PCT No.: PCT/CN2016/070305

§ 371 Date: Jan. 21, 2016

(30) Foreign Application Priority Data
Dec. 15, 2015 (CN) 201510937284.1

(51) Int. Cl. G02F 1/1343; G02F 1/1362

(52) U.S. Cl. CPC G02F 1/1343; G02F 2001/136222

(57) ABSTRACT

A curved liquid crystal display panel and an array substrate thereof are disposed. The array substrate arranges a plurality of pixel units thereon, and each of the pixel units has a left subdomain and a right subdomain. The array substrate is divided into a central segment, a left segment, and a right segment. In the pixel unit of the left segment, the width of the right subdomain is greater than the width of the left subdomain; and in the pixel unit of the right segment, the width of the left subdomain is greater than the width of the right subdomain. By an asymmetrical design for the subdomains of the pixel units, the position offset generated during the panel is formed can be compensated, so as to improve the viewing angle and the color difference of the curved panel.

### FIELD OF THE INVENTION

The present invention relates to a curved liquid crystal display panel and an array substrate thereof, and more particularly to a curved liquid crystal display panel and an array substrate thereof which have an asymmetrical design in subdomains of a pixel unit.

### BACKGROUND OF THE INVENTION

A liquid crystal display (LCD) panel disposes a liquid crystal layer between two glass substrates, wherein the upper glass is a color filter (CF) substrate, and the lower glass is an array substrate inlaid with thin film transistors (TFT). For increasing the aperture ratio of the LCD panel and lowering the manufacturing cost, a color filter on array (COA) technology is adopted in the present array substrate. That is, the manufacturing of red-green-blue (RGB) three colors color resists is moved from the CF substrate to the array substrate, and the opposite substrate only keeps a black matrix (BM) film and transparent conductive film (ITO) electrodes, etc. To go a step further, the manufacturing of the black matrix (BM) film is moved to the array substrate, called “black matrix on array” (BOA) technology.

Refer now to FIG. 1, which is a schematic side cross-sectional view of a traditional curved liquid crystal display panel. A traditional curved LCD panel 90 mainly comprises an array substrate 91 and an opposite substrate 92. A reason for the panel 90 having a light leakage phenomenon is that: after the panel 90 is curved, the curvature radiuses of the array substrate 91 and the opposite substrate 92 are different, and this causes the relative positions of the array substrate 91 and the opposite substrate 92 to be shifted along a length direction, namely in the curved direction. As shown in FIG. 1, near the left side of the panel 90, a relative position of the opposite substrate 92 corresponding to the array substrate 91 is shifted leftward for a distance d1 compared with the panel before being curved; and near the right side of the panel 90, a relative position of the opposite substrate 92 corresponding to the array substrate 91 is shifted rightward for a distance d2 compared with the panel before being curved.

Therefore, if the panel 90 adopts the COA technology, pixels on the array substrate 91 and the BM film on the opposite substrate 92 will be shifted, and this causes the problems of light leakage, crosstalk, etc. Additionally, if the panel 90 adopts the BOA technology, since the black matrix film is formed on the array substrate, so that the problems of light leakage, crosstalk, etc. caused by the shift of the relative position will not happen.

However, no matter whether the COA technology or the BOA technology is adopted, there is still a problem which cannot be solved, that is: when an “High Vertical Alignment” (HVA) photo-align technology is used for the photo-align operation of the panel 90, in each domain of the pixel, there is a liquid crystal dumping phenomenon between the lower substrate (array substrate) and the upper substrate (opposite substrate) caused by an offset of predefined inclination angles. That is, in the HVA technology, the upper and lower substrates align liquid crystal molecules by a polyimide (PI) film, and after a liquid crystal cell is assembled, the liquid crystal molecules are slanted by applying voltage, and then they are emitted with a ultraviolet (UV) to fix the predefined inclination angles. The align angles are relative to the applying voltage directions of the liquid crystal, so that the align angles of the upper and lower substrates will cause a liquid crystal dumping phenomenon when the panel is bent.

One of the solutions for the above-mentioned liquid crystal dumping phenomenon is by using an UVVA (UV2A, Ultraviolet Induced Multi-domain Vertical Alignment) photo-align technology, that is firstly to respectively align the polyimides of the upper and lower substrates, and to assemble the liquid crystal cell, and then to fill the liquid crystal. Refer now to FIGS. 2A-2C, which are schematic views showing a traditional UVVA photo-align technology applied to a curved LCD panel. Specially, in the figures, a pixel unit is used as an example, and in the following text: one pixel electrode of the array substrate 91 is used to represent the whole of the array substrate 91, and one color resist of the opposite substrate 92 is used to represent the whole of the opposite substrate 92. The UVVA photo-align technology is respectively to align the array substrate 91 in a vertical direction and align to the opposite substrate 92 in a horizontal direction, and to assemble the two substrates as a liquid crystal cell, and then to fill the liquid crystal therein, so as to complete a curved LCD panel 90. Therefore, in theory, if the UVVA technology is used, it is possible to design the pixels by a normal panel design, and the transmission ratio can be higher. As shown in FIG. 2A, the liquid crystal molecules have an effect of four domains under a resultant force function of the PI alignment of the upper and lower substrates. Thus, when using the UVVA, it is unnecessary to provide an ITO slit, and the risk of the liquid crystal dumping phenomenon between the subdomains of the adjacent pixels does not exist.

However, as mentioned above, although this photo-align technology can prevent the problem of the liquid crystal dumping phenomenon, there is still an problem, and that is that when the liquid crystal panel which uses the COA technology is bent, the subdomains of some of the pixels have discordant sizes in the left and right two sides, in the shifted places. Since the upper and lower substrates are shifted, in the subdomains of the leftmost pixel unit of the panel, the right subdomains are smaller than the left subdomains (as shown in FIG. 2B), and in the subdomains of the rightmost pixel unit of the panel, the left subdomains are smaller than the right subdomains (as shown in FIG. 2C), so that it will influence the viewing angle and the color difference of the LCD panel.

Hence, it is necessary to provide a curved liquid crystal display panel and an array substrate which solve the problems existing in the conventional technologies.

### SUMMARY OF THE INVENTION

The object of the present invention is to provide a curved liquid crystal display panel and an array substrate thereof. The array substrate arranges a plurality of pixel units thereon, wherein each of the pixel units has a left subdomain and a right subdomain. The array substrate is divided into a central segment, a left segment, and a right segment, wherein in the pixel unit of the left segment, the width of the right subdomain is greater than the width of the left subdomain, and in the pixel unit of the right segment, the width of the left subdomain is greater than the width of the right subdomain, so as to compensate the position offset generated during the panel is formed.

To achieve the above object, the present invention provides a curved liquid crystal display panel, which comprises:
an array substrate arranging a plurality of pixel units thereon, wherein each of the pixel units has a left subdomain and a right subdomain;
an opposite substrate arranging a plurality of unit grids thereon corresponding to the pixel units; and
a liquid crystal layer disposed between the array substrate and the opposite substrate;
wherein the array substrate is divided into a central segment, a left segment, and a right segment; in the pixel unit of the central segment, the width of the right subdomain is equal to the width of the left subdomain; in the pixel unit of the left segment, the width of the right subdomain is greater than the width of the left subdomain; in the leftmost pixel unit of the left segment, the width of the right subdomain is greater than the width of the left subdomain for a difference value, which is a first compensating value; in the pixel unit of the right segment, the width of the left subdomain is greater than the width of the right subdomain; and in the rightmost pixel unit of the right segment, the width of the left subdomain is greater than the width of the right subdomain for a difference value, which is a second compensating value; and wherein the first compensating value is equal to the second compensating value.

In one embodiment of the present invention, the first compensating value is a shifting value between the leftmost pixel unit of the left segment and the corresponding unit grid of the opposite substrate when the panel is bent; and the second compensating value is a shifting value between the rightmost pixel unit of the right segment and the corresponding unit grid of the opposite substrate when the panel is bent.

In one embodiment of the present invention, in the left segment, the difference value, due to the width of the right subdomain is greater than the width of the left subdomain, is progressively decreased from the first compensating value rightward; and in the right segment, the difference value, due to the width of the left subdomain is greater than the width of the right subdomain, is progressively decreased from the second compensating value leftward.

In one embodiment of the present invention, the difference value is decreased based on a linear relation.

In one embodiment of the present invention, the difference value is decreased based on a function relation.

To achieve the above object, the present invention further provides a curved liquid crystal display panel, which comprises:
an array substrate arranging a plurality of pixel units thereon, wherein each of the pixel units has a left subdomain and a right subdomain;
an opposite substrate arranging a plurality of unit grids thereon corresponding to the pixel units; and
a liquid crystal layer disposed between the array substrate and the opposite substrate;
wherein the array substrate is divided into a central segment, a left segment, and a right segment; in the pixel unit of the central segment, the width of the right subdomain is equal to the width of the left subdomain; in the pixel unit of the left segment, the width of the right subdomain is greater than the width of the left subdomain; and in the pixel unit of the right segment, the width of the left subdomain is greater than the width of the right subdomain.

In one embodiment of the present invention, in the leftmost pixel unit of the left segment, the width of the right subdomain is greater than the width of the left subdomain for a difference value, which is a first compensating value; in the rightmost pixel unit of the right segment, the width of the left subdomain is greater than the width of the right subdomain for a difference value, which is a second compensating value; the first compensating value is a shifting value between the leftmost pixel unit of the left segment and the corresponding unit grid of the opposite substrate when the panel is bent; and the second compensating value is a shifting value between the rightmost pixel unit of the right segment and the corresponding unit grid of the opposite substrate when the panel is bent.

In one embodiment of the present invention, the first compensating value is equal to the second compensating value.

In one embodiment of the present invention, in the left segment, the difference value, due to the width of the right subdomain is greater than the width of the left subdomain, is progressively decreased from the first compensating value rightward; and in the right segment, the difference value, due to the width of the left subdomain is greater than the width of the right subdomain, is progressively decreased from the second compensating value leftward.

In one embodiment of the present invention, the difference value is decreased based on a linear relation.

In one embodiment of the present invention, the difference value is decreased based on a function relation.

To achieve the above object, the present invention further provides an array substrate of a curved liquid crystal display panel, which arranges a plurality of pixel units thereon, wherein each of the pixel units has a left subdomain and a right subdomain, and the pixel units corresponds to a plurality of unit grids on an opposite substrate; wherein the array substrate is divided into a central segment, a left segment, and a right segment; in the pixel unit of the central segment, the width of the right subdomain is equal to the width of the left subdomain; in the pixel unit of the left segment, the width of the right subdomain is greater than the width of the left subdomain; and in the pixel unit of the right segment, the width of the left subdomain is greater than the width of the right subdomain.

In one embodiment of the present invention, in the leftmost pixel unit of the left segment, the width of the right subdomain is greater than the width of the left subdomain for a difference value, which is a first compensating value; in the rightmost pixel unit of the right segment, the width of the left subdomain is greater than the width of the right subdomain for a difference value, which is a second compensating value; the first compensating value is a shifting value between the leftmost pixel unit of the left segment and the corresponding unit grid of the opposite substrate when the panel is bent; and the second compensating value is a shifting value between the rightmost pixel unit of the right segment and the corresponding unit grid of the opposite substrate when the panel is bent.

In one embodiment of the present invention, the first compensating value is equal to the second compensating value.

In one embodiment of the present invention, in the left segment, the difference value, due to the width of the right subdomain is greater than the width of the left subdomain, is progressively decreased from the first compensating value rightward; and in the right segment, the difference value, due to the width of the left subdomain is greater than the width of the right subdomain, is progressively decreased from the second compensating value leftward.

In one embodiment of the present invention, the difference value is decreased based on a linear relation.

In one embodiment of the present invention, the difference value is decreased based on a function relation.

### DESCRIPTION OF THE DRAWINGS

FIG. 1 is a schematic side cross-sectional view of a traditional curved liquid crystal display panel;

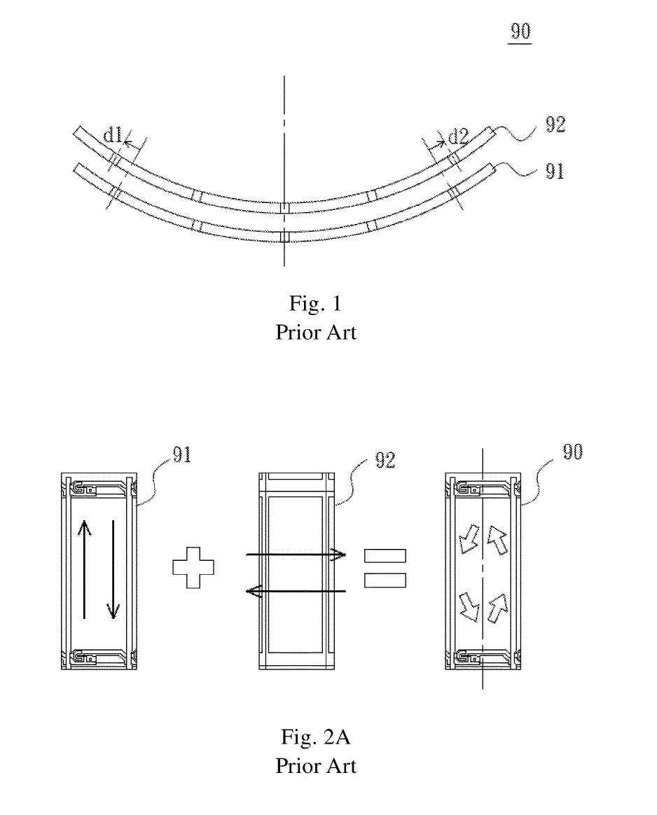

FIGS. 2A-2C are schematic views showing a traditional UVVA photo-align technology applied to a curved liquid crystal display panel;

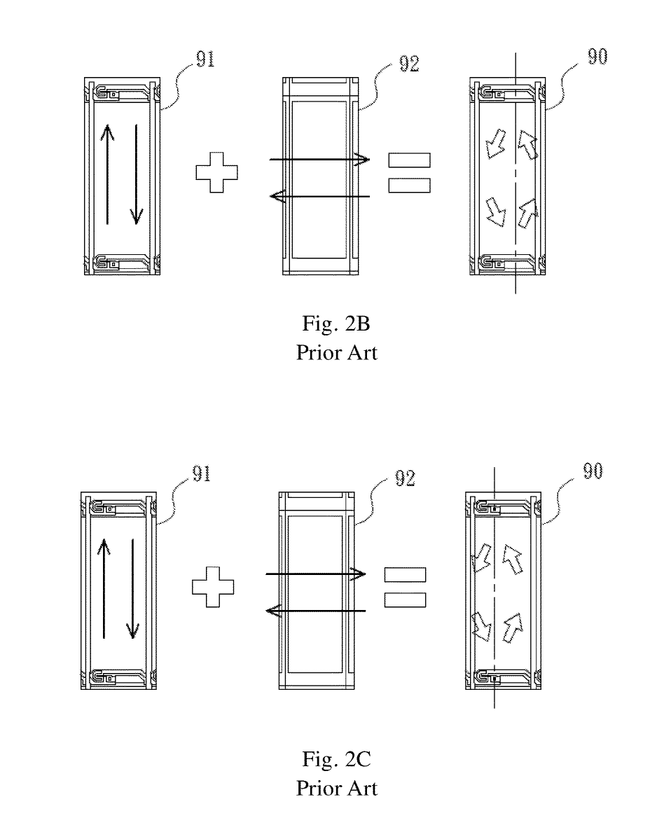

FIG. 3 is a schematic side cross-sectional view of a curved liquid crystal display panel according to a preferred embodiment of the present invention;

FIG. 4 is an orthogonal schematic view of an array substrate according to a preferred embodiment of the present invention; and

FIGS. 5A-5C are partial enlarged views of FIG. 4.

### DETAILED DESCRIPTION OF THE PREFERRED EMBODIMENTS

The foregoing objects, features, and advantages adopted by the present invention can be best understood by referring to the following detailed description of the preferred embodiments and the accompanying drawings. Furthermore, the directional terms described in the present invention, such as upper, lower, front, rear, left, right, inside, outer, side, etc., are only directions with reference to the accompanying drawings, so that the used directional terms are used to describe and understand the present invention, but the present invention is not limited thereto. In the drawings, units with similar structures use the same numerals.

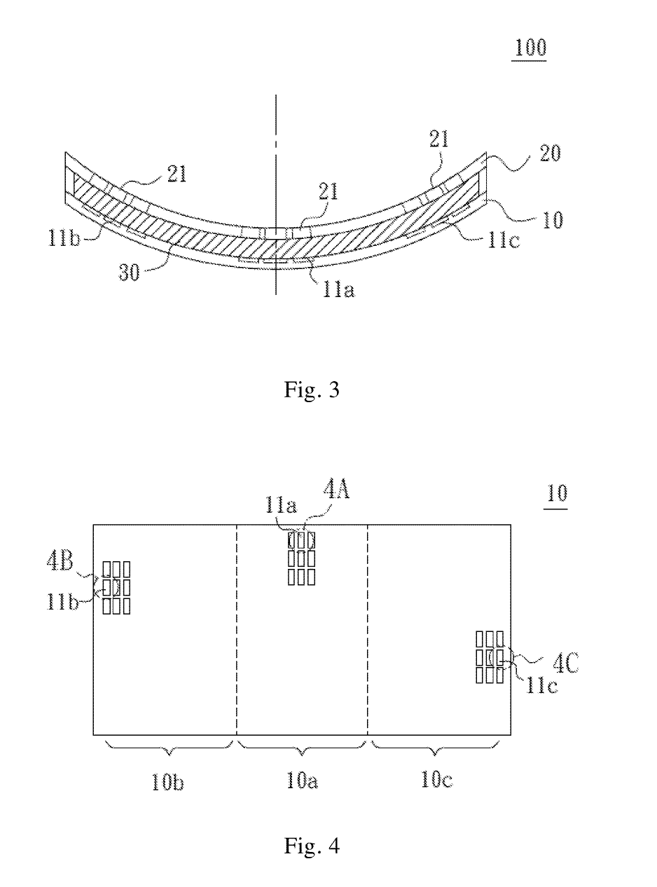

Refer now to FIG. 3, which is a schematic side cross-sectional view of a curved liquid crystal display panel according to a preferred embodiment of the present invention. A curved liquid crystal display panel 100 according to the present invention comprises: an array substrate 10, an opposite substrate 20, and a liquid crystal layer 30. A plurality of pixel units 11 (11a, 11b, 11c) are arranged on the array substrate 10. The pixel units, for example, are defined by a color resist layer and a plurality of pixel electrodes on an inner surface of the array substrate. A plurality of unit grids 21 are arranged on the opposite substrate 20 arranges. The unit grid, for example, are defined by a black matrix layer on an inner surface of the opposite substrate. The curved liquid crystal display panel 100 uses a color filter on array (COA) technology, in which is a manufacturing of red-green-blue (RGB) three colors color resists is moved to the array substrate 100, and the opposite substrate 20 only keeps a black matrix film and transparent conductive film electrodes, etc. Additionally, the pixel electrodes, which is called in the present invention, are actually sub pixels, and usually one display pixel is assembled by three sub pixels, red-green-blue three colors.

As described in the background of the specification, the UVVA photo-align technology is used respectively to align the array substrate in a vertical direction and align the opposite substrate in a horizontal direction, and to assemble the two substrates as a liquid crystal cell, and then to fill the liquid crystal therein, wherein each pixel is formed as a 2×2, and the total is four domains (upper, lower, left, and right). However, although this photo-align technology can prevent the problem of the liquid crystal dumping phenomenon, there is still a problem, and that is, when the liquid crystal panel is bent, the four subdomains of some of the pixels have discordant sizes in the left and right sides, in the shifted places. Since the upper and lower substrates are shifted, in the four subdomains of each of the leftmost side pixel unit of the panel, the two right subdomains are smaller than the two left subdomains, and in the four subdomains of each of the rightmost side pixel unit of the panel, the two left subdomains are smaller than the two right subdomains, so that it will influence the viewing angle and the color difference of the LCD panel. In the following text, it should be noted that: in the present invention, the two right subdomains in the four subdomains in each of the pixels are called “right subdomain”, and the two left subdomains in the four subdomains in each of the pixels are called “left subdomain”.

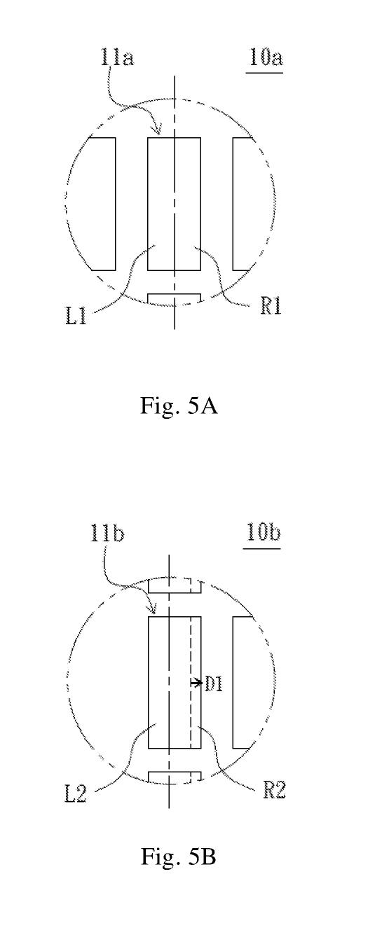

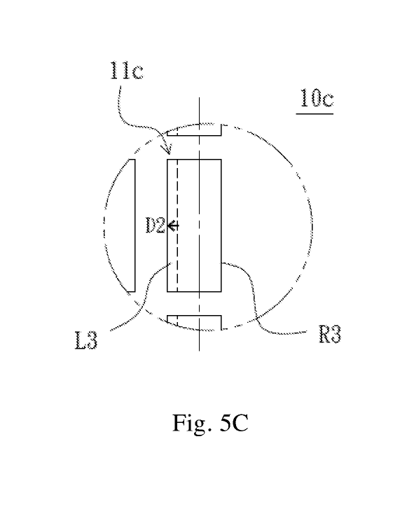

Refer now to FIGS. 4 and 5A-5C, wherein FIG. 4 is an orthogonal schematic view of an array substrate according to a preferred embodiment of the present invention, and FIGS. 5A-5C are partial enlarged views of FIG. 4. In the present invention, for compensating the shifting phenomenon between the array substrate 10 and the opposite substrate 20 caused by the curved liquid crystal display panel 100 being bent, the array substrate 10 is divided into a central segment 10a, a left segment 10b, and a right segment 10c, wherein in the pixel unit 11a of the central segment 10a, the width of the right subdomain R1 is equal to the width of the left subdomain L1 (FIG. 5A); in the pixel unit 11b of the left segment 10b, the width of the right subdomain R2 is greater than the width of the left subdomain L2 (FIG. 5B); and in the pixel unit 11c of the right segment 10c, the width of the left subdomain L3 is greater than the width of the right subdomain R3 (FIG. 5C). By an asymmetrical design for the subdomains of the pixel units 11b, 11c of the left and right segments 10b, 10c of the array substrate 10, it can compensate the position offset between the array substrate 10 and the opposite substrate 20 caused by the curved liquid crystal display panel 100 being bent, so as to improve the viewing angle and the color difference of the curved liquid crystal display panel 100.

As shown in FIG. 5B, in the leftmost pixel unit 11b of the left segment 10b, the width of the right subdomain R2 is greater than the width of the left subdomain L2 for a difference value, which is at least a first compensating value D1; and as shown in FIG. 5C, in the rightmost pixel unit 11c of the right segment 10c, the width of the left subdomain L3 is greater than the width of the right subdomain R3 for a difference value, which is at least a second compensating value D2.

Preferably, the first compensating value D1 is a shifting value between the leftmost pixel unit 11b of the left segment 10b and the corresponding unit grid 21 of the opposite substrate 20 when the panel is bent; and the second compensating value D2 is a shifting value between the rightmost pixel unit 11c of the right segment 10c and the corresponding unit grid 21 of the opposite substrate 20 when the panel is bent. Additionally, if the array substrate 10 is a completely symmetrical curve, the first compensating value D1 is equal to the second compensating value D2.

In the present invention, a designer can obtain the first compensating value D1 and the second compensating value D2 by methods of experience value, computing formula, or experiment. Furthermore, preferably, in the left segment 10b, the difference value, due to the width of the right subdomain R2 is greater than the width of the left subdomain L2, is progressively decreased from the first compensating value D1 rightward; and in the right segment 10c, the difference value, due to the width of the left subdomain L3 is greater than the width of the right subdomain R3, is progressively decreased from the second compensating value D2 leftward. The decreasing methods for the above-mentioned difference value can depend on a linear relation or a function relation.

In the present invention, the width of the right subdomain R2 of the pixel unit 11b of the left segment 10b of the array substrate 10 is greater than the width of the left subdomain L2 thereof; and the width of the left subdomain L3 of the pixel unit 11c of the right segment 10c of the array substrate 10 is greater than the width of the right subdomain R3. By an asymmetrical design for the subdomains of the pixel units 11b, 11c, it can compensate the position offset caused by the panel being bent, so as to improve the viewing angle and the color difference of the curved panel.

The present invention has been described with preferred embodiments thereof and it is understood that many changes and modifications to the described embodiment can be carried out without departing from the scope and the spirit of the invention that is intended to be limited only by the appended claims.

What is claimed is:

1. A curved liquid crystal display panel, comprising:
an array substrate arranging a plurality of pixel units thereon, wherein each of the pixel units has a left subdomain and a right subdomain;
an opposite substrate arranging a plurality of unit grids thereon, the unit grids being corresponding to the pixel units; and
a liquid crystal layer disposed between the array substrate and the opposite substrate;
wherein the array substrate is divided into a central segment, a left segment, and a right segment; in the pixel unit of the central segment, the width of the right subdomain is equal to the width of the left subdomain; in the pixel unit of the left segment, the width of the right subdomain is greater than the width of the left subdomain; in the leftmost pixel unit of the left segment, the width of the right subdomain is greater than the width of the left subdomain for a difference value, which is a first compensating value; in the pixel unit of the right segment, the width of the left subdomain is greater than the width of the right subdomain; and in the rightmost pixel unit of the right segment, the width of the left subdomain is greater than the width of the right subdomain for a difference value, which is a second compensating value; and wherein the first compensating value is equal to the second compensating value.

2. The curved liquid crystal display panel according to claim 1, wherein the first compensating value is a shifting value between the leftmost pixel unit of the left segment and the corresponding unit grid of the opposite substrate when the panel is bent; and the second compensating value is a shifting value between the rightmost pixel unit of the right segment and the corresponding unit grid of the opposite substrate when the panel is bent.

3. The curved liquid crystal display panel according to claim 2, wherein in the left segment, the difference value, due to the width of the right subdomain is greater than the width of the left subdomain, is progressively decreased from the first compensating value rightward; and in the right segment, the difference value, due to the width of the left subdomain is greater than the width of the right subdomain, is progressively decreased from the second compensating value leftward.

4. The curved liquid crystal display panel according to claim 3, wherein the difference value is decreased based on a linear relation.

5. The curved liquid crystal display panel according to claim 3, wherein the difference value is decreased based on a function relation.

6. A curved liquid crystal display panel, comprising:
an array substrate arranging a plurality of pixel units thereon, wherein each of the pixel units has a left subdomain and a right subdomain;
an opposite substrate arranging a plurality of unit grids thereon, the unit grids being corresponding to the pixel units; and
a liquid crystal layer disposed between the array substrate and the opposite substrate;
wherein the array substrate is divided into a central segment, a left segment, and a right segment; in the pixel unit of the central segment, the width of the right subdomain is equal to the width of the left subdomain; in the pixel unit of the left segment, the width of the right subdomain is greater than the width of the left subdomain; and in the pixel unit of the right segment, the width of the left subdomain is greater than the width of the right subdomain.

7. The curved liquid crystal display panel according to claim 6, wherein in the leftmost pixel unit of the left segment, the width of the right subdomain is greater than the width of the left subdomain for a difference value, which is a first compensating value; in the rightmost pixel unit of the right segment, the width of the left subdomain is greater than the width of the right subdomain for a difference value, which is a second compensating value; the first compensating value is a shifting value between the leftmost pixel unit of the left segment and the corresponding unit grid of the opposite substrate when the panel is bent; and the second compensating value is a shifting value between the rightmost pixel unit of the right segment and the corresponding unit grid of the opposite substrate when the panel is bent.

8. The curved liquid crystal display panel according to claim 7, wherein the first compensating value is equal to the second compensating value.

9. The curved liquid crystal display panel according to claim 7, wherein in the left segment, the difference value, due to the width of the right subdomain is greater than the width of the left subdomain, is progressively decreased from the first compensating value rightward; and in the right segment, the difference value, due to the width of the left subdomain is greater than the width of the right subdomain, is progressively decreased from the second compensating value leftward.

10. The curved liquid crystal display panel according to claim 9, wherein the difference value is decreased based on a linear relation.

11. The curved liquid crystal display panel according to claim 9, wherein the difference value is decreased based on a function relation.

12. An array substrate of a curved liquid crystal display panel, which arranges a plurality of pixel units thereon, wherein each of the pixel units has a left subdomain and a right subdomain, and the pixel units corresponds to a plurality of unit grids on an opposite substrate; wherein the array substrate is divided into a central segment, a left segment, and a right segment; in the pixel unit of the central segment, the width of the right subdomain is equal to the width of the left subdomain; in the pixel unit of the left segment, the width of the right subdomain is greater than the width of the left subdomain; and in the pixel unit of the right segment, the width of the left subdomain is greater than the width of the right subdomain.

13. The array substrate according to claim 12, wherein in the leftmost pixel unit of the left segment, the width of the right subdomain is greater than the width of the left subdomain for a difference value, which is a first compensating value; in the rightmost pixel unit of the right segment, the width of the left subdomain is greater than the width of the right subdomain for a difference value, which is a second compensating value; the first compensating value is a shifting value between the leftmost pixel unit of the left segment and the corresponding unit grid of the opposite substrate when the panel is bent; and the second compensating value is a shifting value between the rightmost pixel unit of the right segment and the corresponding unit grid of the opposite substrate when the panel is bent.

14. The array substrate according to claim 13, wherein the first compensating value is equal to the second compensating value.

15. The array substrate according to claim 13, wherein in the left segment, the difference value, due to the width of the right subdomain is greater than the width of the left subdomain, is progressively decreased from the first compensating value rightward; and in the right segment, the difference value, due to the width of the left subdomain is greater than the width of the right subdomain, is progressively decreased from the second compensating value leftward.

16. The array substrate according to claim 15, wherein the difference value is decreased based on a linear relation.

17. The array substrate according to claim 15, wherein the difference value is decreased based on a function relation.
